(19) United States
(12) Patent Application Publication
(10) Pub. No.: US 2025/0376985 A1
(43) Pub. Date: Dec. 11, 2025

(54) MOTOR, BLOWER, AND CLOTHING ACCESSORY

(71) Applicant: NIDEC CORPORATION, Kyoto (JP)

(72) Inventors: Takuro KAWANO, Kyoto (JP); Hiroshi WATANABE, Kyoto (JP); Keisuke KOZONO, Kyoto (JP); Shinji NAKAGAWA, Kyoto (JP); Yu NONAKA, Kyoto (JP)

(21) Appl. No.: 18/878,104

(22) PCT Filed: Jun. 29, 2023
(86) PCT No.: PCT/JP2023/024113

§ 371 Date: Dec. 23, 2024

(30) Foreign Application Priority Data
Jun. 30, 2022 (JP) 2022-105647
Nov. 29, 2022 (JP) 2022-189970

(51) Int. Cl. F04D 25/06; A41D 13/002; F04D 17/08; F04D 29/42; H02K 11/33

(52) U.S. Cl. CPC F04D 25/064; A41D 13/0025; F04D 17/08; F04D 25/0673; F04D 29/4226; H02K 11/33; F05D 2270/807

(57) ABSTRACT

A motor includes a rotor, a stator, a housing, an acceleration sensor, and controller. The rotor is rotatable about a central axis extending in an axial direction. The stator is operable to drive the rotor. The housing accommodates the rotor and the stator. The acceleration sensor is operable to detect acceleration applied to the housing. The controller is configured or programmed to control energization to the stator. Based on a detection result of the acceleration sensor, the controller is configured or programmed to perform a rotation speed change of any of a rotation start of the rotor, at least one of an increase and a decrease of a rotation speed, and a rotation stop.

### CROSS-REFERENCE TO RELATED APPLICATIONS

This is a U.S. national stage of application No. PCT/JP2023/024113, filed on Jun. 29, 2023, with priority under 35 U.S.C. § 119(a) and 35 U.S.C. § 365(b) being claimed from Japanese Patent Application No. 2022-105647, filed on Jun. 30, 2022, and Japanese Patent Application No. 2022-189970, filed on Nov. 29, 2022, the entire disclosures of which are hereby incorporated herein by reference.

### 1. Field of the Invention

The present invention relates to motors, blowers, and clothing accessories.

### 2. Background

Conventionally, a blower that cools the inside of clothing is known. For example, a cooling blower is attached to clothing and is connected to a portable power supply via a cable. The portable power supply includes a power switch and an operation switch for setting air volume.

However, in the above-described blower, a portable power supply in which various switches are arranged is externally connected to the blower. For this reason, when switching of operation such as turning on and off the power supply and setting air volume is performed, it is necessary to operate the power switch and the operation switch after taking out the portable power supply.

### SUMMARY

An example embodiment of a motor of the present invention includes a rotor, a stator, a housing, an acceleration sensor, and a controller. The rotor is rotatable about a central axis extending in an axial direction. The stator is operable to drive the rotor. The housing accommodates the rotor and the stator. The acceleration sensor is operable to detect acceleration applied to the housing. The controller is configured or programmed to control energization to the stator. Based on a detection result of the acceleration sensor, the controller is configured or programmed to perform a rotation speed change of any of a rotation start of the rotor, at least one of an increase and a decrease of a rotation speed, and a rotation stop.

Further, an example embodiment of a blower according to the present invention includes the motor and an impeller. The impeller is accommodated in the housing and is rotatable together with the rotor about the central axis. The impeller includes a hub and an impeller blade. The hub is attached to the rotor. The impeller blade extends radially outward from the hub and extends at least in the axial direction. The housing includes a peripheral wall portion, a canopy portion, a first opening, and a second opening. The peripheral wall portion is located radially outward of the impeller and surrounds the impeller. The canopy portion extends in a radial direction, is arranged further in one axial direction than the rotor, and the stator, the impeller, and covers one axial end portion of the peripheral wall portion. The first opening is located in the peripheral wall portion and connects an internal space surrounded by the peripheral wall portion and an external space of the housing. The second opening is located in the canopy portion and connects an internal space surrounded by the peripheral wall portion and an external space of the housing.

Further, an exemplary clothing accessory according to an example embodiment of the present invention includes the above-described blower.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a cross-sectional view illustrating a configuration example of a blower according to the present example embodiment as viewed from an axial direction.

FIG. 2 is a cross-sectional view illustrating a configuration example of the blower viewed from a radial direction;

FIG. 3 is an external view of the blower.

FIG. 4 is a block diagram illustrating a configuration example of a control system of the blower.

FIG. 5 is a perspective view illustrating a charging example of the blower.

FIG. 6A is a flowchart illustrating a control example of a motor and the blower.

FIG. 6B is a flowchart illustrating another control example of the motor and the blower.

FIG. 7 is a schematic view illustrating an example of a clothing accessory to which the blower is attached.

FIG. 8A is an enlarged view illustrating an attaching example of the blower according to an application example as viewed from the inside of the clothing accessory.

FIG. 8B is an enlarged view illustrating another attaching example of the blower according to the application example as viewed from the inside of the clothing accessory.

FIG. 9A is an enlarged view illustrating an attaching example of the blower according to another application example as viewed from the inside of the clothing accessory.

FIG. 9B is an enlarged view illustrating another attaching example of the blower according to another application example as viewed from the inside of the clothing accessory.

### DETAILED DESCRIPTION

Hereinafter, example embodiments will be described with reference to the drawings.

Note that, in the present description, a direction parallel to a central axis CA is referred to as an “axial direction”. In the axial direction, a direction from a bracket 37 to a canopy portion 34 is referred to as “one axial direction D1”, and a direction from the canopy portion 34 to the bracket 37 is referred to as “the other axial direction D2”. A direction orthogonal to the central axis CA is referred to as a “radial direction”, and a rotation direction about the central axis CA is referred to as a “circumferential direction”. In the radial direction, a direction approaching the central axis CA is referred to as “radially inward”, and a direction away from the central axis CA is referred to as “radially outward”.

Further, in the present description, an “annular shape” includes not only a shape continuously connected without any cut along the entire circumference in the circumferential direction around the central axis CA, but also a shape having one or more cuts in a part of the entire circumference around the central axis CA. Further, the “annular shape” also includes a shape having a closed curve on a curved surface that intersects the central axis CA around the central axis CA.

Further, in a positional relationship between any of an azimuth, a line, and a plane and another one of them, the term “parallel” includes not only a state in which they do not intersect even if they extend endlessly but also a state in which they are substantially parallel. Further, the terms “perpendicular” and “orthogonal” include not only a state in which both of them intersect each other at 90 degrees, but also a state in which they are substantially perpendicular and a state in which they are substantially orthogonal. That is, each of the terms “parallel”, “perpendicular”, and “orthogonal” includes a state in which a positional relationship between them has an angular deviation that does not depart from the gist of the present invention.

Note that, these terms are names used merely for description, and are not intended to limit actual positional relationships, directions, names, and the like.

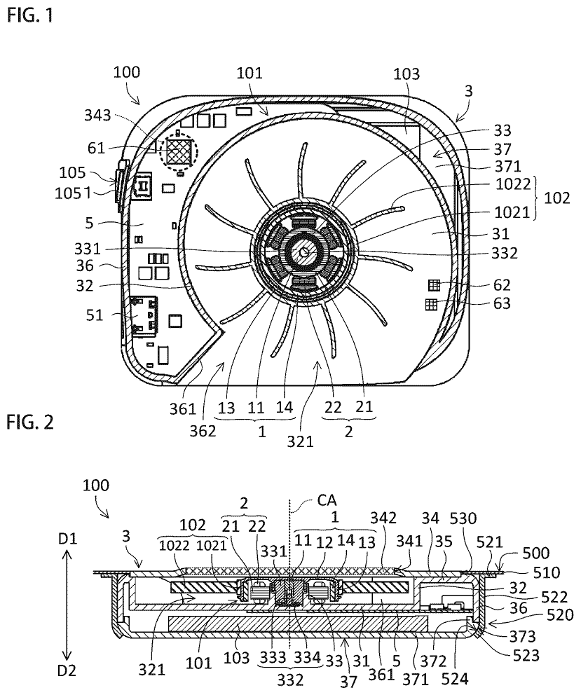

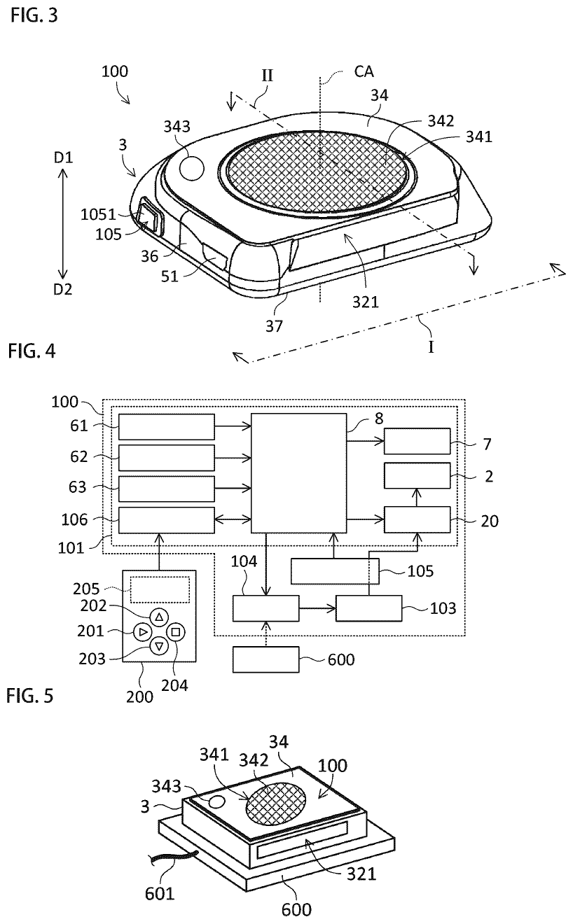

FIG. 1 is a cross-sectional view illustrating a configuration example of a blower 100 according to the present example embodiment as viewed from the axial direction. FIG. 2 is a cross-sectional view illustrating a configuration example of the blower 100 as viewed from the radial direction. FIG. 3 is an external view of the blower 100. FIG. 4 is a block diagram illustrating a configuration example of a control system of the blower 100. FIG. 5 is a perspective view illustrating a charging example of the blower 100. Note that, in FIG. 1, a cross-sectional structure of the blower 100 taken along a virtual plane including an alternate long and short dash line I in FIG. 3 and perpendicular to the axial direction is viewed from the one axial direction D1 to the other axial direction D2. FIG. 2 illustrates a cross-sectional structure of the blower 100 taken along a virtual plane including an alternate long and short dash line II in FIG. 3 and parallel to the axial direction as viewed from the radial direction.

As illustrated in FIGS. 1 and 2, the blower 100 is a centrifugal fan, sucks air from an intake port 341, and delivers airflow from an exhaust port 321. The blower 100 of the present example embodiment is attached to, for example, a clothing accessory 500 (see FIG. 7 described later) such as clothing. However, this exemplification does not limit the use of the blower 100.

The blower 100 includes a motor 101 and an impeller 102. The motor 101 rotationally drives the impeller 102. The impeller 102 is fixed to a rotor 1 described later of the motor 101. The impeller 102 is rotatable together with the rotor 1 about the central axis CA. The impeller 102 includes a hub 1021 and an impeller blade 1022. The hub 1021 is attached to the rotor 1. The impeller blade 1022 extends radially outward from the hub 1021 and expands at least in the axial direction. Specifically, the hub 1021 has a tubular shape extending in the axial direction, and is fixed to a radially outer surface of a rotor tube portion 13 described later of the rotor 1. A plurality of the impeller blades 1022 are arranged in the circumferential direction. The impeller blade 1022 is rotatable in the circumferential direction about the central axis CA extending in the axial direction according to rotation of the rotor 1. In the present example embodiment, the impeller blade 1022 rotates clockwise with respect to the central axis CA in FIG. 1.

Further, the blower 100 further includes a battery 103. The battery 103 is a chargeable and dischargeable power supply unit, and is a secondary battery such as a Li-ion battery in the present example embodiment. The battery 103 supplies power to each constituent element of the blower 100 (and the motor 101).

Further, the blower 100 further includes a power receiver 104. For example, as illustrated in FIG. 4, the power receiver 104 can wirelessly receive power from an external power feeding device 600, and charges the battery 103 with the received power. For example, the power receiver 104 includes a coil (not illustrated) for receiving power electrically connected to the battery 103. Further, the power feeding device 600 includes a coil (not illustrated) for transmitting power. Note that an axis passing through the center of the coil for transmitting power is directed in the same direction as an axis passing through the center of the coil for receiving power, and passes through the inside of the power receiving coil. The coil for transmitting power is electrically connected to an external power source (for example, an outlet to which power is supplied from a commercial power network) via a power supply line 601. When the blower 100 is placed on the power feeding device 600, the coil for transmitting power through which current flows from the power supply line 601 generates a magnetic flux toward the coil for receiving power. This magnetic flux passes through the inside of the coil for receiving power, and generates current in the coil for receiving power by electromagnetic induction. The current is supplied to the battery 103 to charge the battery 103. Note that when a charge amount of the battery 103 is a predetermined amount (for example, 80% to 100% of maximum capacity) or more, charging of the battery 103 is stopped. For example, energization of the coil for receiving power is cut off by the control of a controller 8 described later.

In the above manner, for example, by placing the blower 100 on the power feeding device 600, the battery 103 can be wirelessly charged. Therefore, it is not necessary to establish wired connection with the external power feeding device 600. Therefore, the battery 103 can be easily charged.

Further, by enabling wireless charging, it is also possible to omit arrangement of a connector portion (for example, a connector 51) for charging, a power supply line, and the like for wired charging. By the above, water and dust are less likely to enter the inside of a housing 3 (particularly, a substrate 5), so that waterproof and dustproof properties of the blower 100 can be improved.

Note that the above exemplification does not exclude a configuration in which the battery 103 and the power receiver 104 are omitted. Further, a portable external power supply device may be connectable to the blower 100 by wire.

Further, the blower 100 further includes a switch 105. In the present example embodiment, the switch 105 is arranged at a radially outer end portion (for example, a first outer wall portion 36 described later) of the blower 100. However, the present invention is not limited to this exemplification, and the switch 105 may be arranged at another axial end portion (for example, a bottom plate portion 371 to be described later) of the blower 100. The switch 105 is a power supply changeover switch of the blower 100 and the motor 101, and can switch between ON and OFF by operation of a changeover portion 1051 described later. As the changeover portion 1051, any one of a push button, a see-saw type button, an operation lever, a slide lever, and the like can be employed. That is, for example, any of a push button switch, a see-saw switch, a toggle switch, a dip switch, and the like can be employed as the switch 105.

For example, the switch 105 can stop at least power supply of the battery 103. By the above, the blower 100 and the motor 101 can be made undrivable. By stopping power supply from the battery 103 to each constituent element of the blower 100 by operation of the switch 105, power consumption of the blower 100 and the motor 101 (in particular, the controller 8) can be prevented, and in particular, standby power consumption of these can be prevented. That is, when the blower 100 is not used, power consumption of the blower 100 (and the motor 101) is completely stopped, so that decrease in an amount of stored electricity in the battery 103 can be prevented. Therefore, the blower 100 can be used for longer time without recharging.

Further, preferably, the blower 100 further includes a communication portion 106. The communication portion 106 can communicate with an external device of the blower 100, and can wirelessly communicate with an external operation device 200, for example, as illustrated in FIG. 4. Note that the above exemplification does not exclude a configuration in which the communication portion 106 can perform wired communication. For example, wired communication with an external device may be possible via a communication line connected to a connector 51 to be described later.

The operation device 200 is, for example, a portable remote controller. For example, as illustrated in FIG. 4, the operation device 200 includes a rotation start button 201, a rotation speed increase button 202, a rotation speed decrease button 203, a rotation stop button 204, and a transmission unit 205. The rotation start button 201 receives operation input of rotation start of the rotor 1 (that is, air blowing start). The rotation speed increase button 202 receives operation input for increasing a rotation speed of the rotor 1 (that is, air volume). The rotation speed decrease button 203 receives operation input for decreasing a rotation speed of the rotor 1 (that is, air volume). The rotation stop button 204 receives operation input of rotation stop of the rotor 1 (that is, air blowing stop). Further, the transmission unit 205 can communicate with the communication portion 106, and transmits operation input received by the operation device 200 as an input signal.

In addition to the above, at least one of the blower 100 and the operation device 200 may further include an input unit that receives other operation input.

Note that the above exemplification does not exclude a configuration in which the communication portion 106 and the operation device 200 are omitted.

Next, a configuration of the motor 101 will be described. The motor 101 includes the rotor 1 that is rotatable about the central axis CA extending in the axial direction. The motor 101 further includes a stator 2, the housing 3, the substrate 5, an acceleration sensor 61, a temperature sensor 62, a humidity sensor 63, a storage unit 7, and the controller 8.

The rotor 1 is rotatable about the central axis CA extending in the axial direction. As described above, the motor includes the rotor 1. The rotor 1 includes a shaft 11, a rotor lid portion 12, a rotor inner tube portion (reference numeral is omitted), a rotor tube portion 13, a rotor yoke (not illustrated), and a magnet 14. The center viewed from the axial direction of these coincides with the central axis CA. The shaft 11 extends along the central axis CA. One axial end portion of the shaft 11 is connected to the rotor lid portion 12. The rotor lid portion 12 extends radially outward from the shaft 11. The rotor inner tube portion is arranged on the radially inward side of the rotor lid portion 12. The rotor inner tube portion has a tubular shape extending in the other axial direction D2 from the rotor lid portion 12, and is arranged between one axial end portion of a bearing holder 33 described later and one axial end portion of a first bearing 331. The rotor tube portion 13 extends in the other axial direction D2 from a radially outer end portion of the rotor lid portion 12 and surrounds the stator 2. The rotor yoke is a magnetic body arranged on a radially inner surface of the rotor tube portion 13, and has a tubular shape extending in the axial direction in the present example embodiment. Alternatively, the rotor yoke may have a plate shape extending in the axial direction and include a plurality of yoke pieces arranged in the circumferential direction. The magnet 14 is arranged radially outward of the stator 2 and surrounds the stator 2. The magnet 14 is arranged on a radially inner surface of the rotor yoke. However, the present invention is not limited to this exemplification, and the rotor yoke may be omitted. That is, the magnet 14 may be arranged on a radially inner surface of the rotor tube portion 13. The magnet 14 includes magnetic poles (N pole and S pole) different from each other that are alternately arranged in the circumferential direction. The magnet 14 may have an annular shape surrounding the central axis CA, or may include a plurality of magnet pieces arranged in the circumferential direction.

The stator 2 faces the magnet 14 in the radial direction. The stator 2 includes a stator core 21, an insulator (not illustrated), and a coil portion 22. The stator core 21 includes a magnetic material, and in the present example embodiment, is a laminate of a plurality of plate-like electromagnetic steel plates laminated in the axial direction. The stator core 21 faces the magnet 14 in the radial direction. The insulator is made from an electrically insulating material such as resin, and is arranged on a surface of the stator core 21. The coil portion 22 is a member in which a conductive wire (not illustrated) is arranged on the stator core 21 with an insulator interposed between them, and a plurality of the coil portions 22 are arranged in the circumferential direction. The conductive wire is, for example, an enamel-coated copper wire, a metal wire coated with an insulating member, or the like. When drive current is supplied to the coil portion 22, the stator 2 is excited. By the above, the stator 2 drives the rotor 1. As described above, the motor 101 includes the stator 2.

The housing 3 accommodates the rotor 1 and the stator 2. As described above, the motor 101 includes the housing 3. Further, the housing 3 further accommodates the substrate 5, the impeller 102, the battery 103, and the like.

The housing 3 includes a base portion 31, a peripheral wall portion 32, the bearing holder 33, the first bearing 331, a second bearing 332, the canopy portion 34, a lid portion 35, the first outer wall portion 36, and the bracket 37.

The base portion 31 has a plate shape expanding in the radial direction, and is arranged further in the other axial direction D2 than the impeller 102, the rotor 1, and the stator 2. A part of the substrate 5 is arranged on the other axial end surface of the base portion 31.

The peripheral wall portion 32 is arranged radially outward of the impeller 102 and surrounds the impeller 102. As described above, the housing 3 includes the peripheral wall portion 32. Specifically, the peripheral wall portion 32 protrudes in the one axial direction D1 from a radially outer end portion of the base portion 31 and extends in the circumferential direction. The peripheral wall portion 32 has an arc shape surrounding the impeller blade 1022 when viewed from the axial direction.

The peripheral wall portion 32 has the exhaust port 321. When viewed from the axial direction, the exhaust port 321 is an opening between one circumferential end portion and another circumferential end portion of the peripheral wall portion 32. The exhaust port 321 is arranged in the peripheral wall portion 32 and connects an internal space surrounded by the peripheral wall portion 32 and an external space of the housing 3. As described above, the exhaust port 321 is a part of a “first opening” of the present invention. The housing 3 has the exhaust port 321.

Note that the peripheral wall portion 32 is gradually separated radially outward from the central axis CA toward the front side in a rotation direction of the impeller blade 1022 on the front side in the rotation direction when viewed from the axial direction. That is, an internal space surrounded by the peripheral wall portion 32 becomes wider in the radial direction from a left circumferential end portion of the exhaust port 321 in FIG. 1 toward the circumferential direction clockwise with respect to the central axis CA.

The bearing holder 33 has a tubular shape extending in the axial direction, and protrudes in the one axial direction D1 from the radially inner side of the base portion 31. The bearing holder 33 holds the first bearing 331 and the second bearing 332. Furthermore, the bearing holder 33 rotatably supports the shaft 11 via the first bearing 331 and the second bearing 332.

Specifically, the first bearing 331 is arranged on a radially inner surface of the bearing holder 33. The first bearing 331 is a plain bearing in the present example embodiment. The first bearing 331 has a tubular shape extending in the axial direction. The shaft 11 is inserted through the first bearing 331.

Further, the second bearing 332 is formed from a material having excellent slidability, and is arranged in a bottom portion on the other axial direction D2 side of the bearing holder 33. The second bearing 332 includes a column portion 333 and a flange portion 334. The column portion 333 extends along the axial direction and is inserted into a hole portion (reference numeral is omitted) extending in the one axial direction D1 from another axial end portion of the shaft 11. The center of the hole portion and the column portion 333 coincide with the central axis CA. The flange portion 334 is arranged on a bottom surface on the other axial direction D2 side of the bearing holder 33 and expands radially outward from another axial end portion of the column portion 333.

Further, the bearing holder 33 holds the stator 2. Specifically, the stator core 21 is fixed to a radially outer surface of the bearing holder 33.

The canopy portion 34 expands in the radial direction, is arranged further in the one axial direction DI than the impeller 102, the rotor 1, and the stator 2, and covers one axial end portion of the peripheral wall portion 32. As described above, the housing 3 includes the canopy portion 34. The canopy portion 34 includes the intake port 341, a guard portion 342, and a mark portion 343.

The intake port 341 is arranged in the canopy portion 34 and connects an internal space surrounded by the peripheral wall portion 32 and an external space of the housing 3. The intake port 341 is a part of a “second opening” of the present invention. The housing 3 has the intake port 341. The intake port 341 is an opening of the canopy portion 34, and overlaps the impeller 102 (in particular, the impeller blade 1022) when viewed from the axial direction. In the present example embodiment, a radially outer end portion of the intake port 341 is arranged radially inward of a radially outer end portion of the impeller blade 1022. However, the present invention is not limited to this exemplification, and a radially outer end portion of the intake port 341 may be at the same radial position as a radially outer end portion of the impeller blade 1022, or may be arranged radially outward of a radially outer end portion of the impeller blade 1022.

The guard portion 342 has air permeability and is arranged in the intake port 341. The guard portion 342 is, for example, a frame body in which a plurality of linear members extend radially from the center when viewed from the axial direction, and covers the intake port 341. Note that a shape of the guard portion 342 is not limited to this exemplification, and may be, for example, a mesh shape.

The guard portion 342 prevents contact between the impeller 102 and a user's hand or the like. Further, the guard portion 342 (or the intake port 341) may be provided with a filter that prevents dust from entering from the outside. However, this exemplification does not exclude a configuration in which the filter is not arranged.

The mark portion 343 has specific display or shape, and is arranged on a surface of the canopy portion 34. The housing 3 has the mark portion 343. Specifically, the mark portion 343 is arranged on one axial end surface of a portion other than the intake port 341 of the canopy portion 34. The mark portion 343 indicates, to the user, a place suitable for performing operation (such as tapping) of applying an impact (acceleration equal to or more than a threshold) to the housing 3. In the present example embodiment, the mark portion 343 is display drawn on a surface of the canopy portion 34, but may be a member arranged on a surface of the canopy portion 34.

The lid portion 35 extends radially outward from one axial end portion of the peripheral wall portion 32. The lid portion 35 is arranged at one axial end portion of the peripheral wall portion 32 and one axial end portion of the first outer wall portion 36 to cover a space between the two.

The first outer wall portion 36 extends in the other axial direction D2 from a radially outer end portion of the lid portion 35 and expands in the circumferential direction. The first outer wall portion 36 is arranged radially outward of the peripheral wall portion 2 and surrounds s the peripheral wall portion 32. The first outer wall portion 36 has an arc shape surrounding the peripheral wall portion 32 when viewed from the axial direction. In the present example embodiment, the first outer wall portion 36 has a guide wall 361. The guide wall 361 extends from one circumferential end portion (circumferential end portion on the left in FIG. 1) of the first outer wall portion 36 to one circumferential end portion of the peripheral wall portion 32 when viewed from the axial direction, and connects the two. The guide wall 361 further expands in the axial direction. Further, another circumferential end portion (circumferential end portion on the right in FIG. 1) of the first outer wall portion 36 is connected to another circumferential end portion of the peripheral wall portion 32.

Further, the guide wall 361 constitutes an airflow passage 362 together with the base portion 31, the canopy portion 34, the peripheral wall portion 32, and another circumferential end portion (circumferential end portion on the right in FIG. 1) of the first outer wall portion. Airflow passing through the airflow passage 362 is delivered from the exhaust port 321 and delivered to the outside of the housing 3.

The bracket 37 is arranged in the other axial direction D2 of the first outer wall portion 36 and covers the first outer wall portion 36. The bracket 37 constitutes, together with the base portion 31, the first outer wall portion 36, and the like, a space in which the substrate 5 and the battery 103 are accommodated.

The bracket 37 includes the bottom plate portion 371, a second outer wall portion 372, and a first curved surface 373.

The bottom plate portion 371 is arranged further in the other axial direction D2 than the base portion 31 and expands in the radial direction. The battery 103 is arranged on one axial end surface of the bottom plate portion 371.

The second outer wall portion 372 extends in the one axial direction DI from a radially outer end portion of the bottom plate portion 371 and extends in the circumferential direction. The second outer wall portion 372 has an annular shape surrounding the battery 103 and is connected to another axial end portion of the first outer wall portion 36.

The first curved surface 373 is a curved surface inclined in the one axial direction DI as extending radially outward, and extends in the circumferential direction. The first curved surface 373 is arranged between another axial end surface and radially outer surface of the housing 3. Specifically, the first curved surface 373 extends along an outer edge portion (radially outer end portion) of another axial end portion of the bracket 37 (or the housing 3). The first curved surface 373 is what is called an R-chamfered portion and is formed at a corner formed by a radially outer end portion of the bottom plate portion 371 and another axial end portion of the second outer wall portion 372.

Various electronic components such as a drive circuit (for example, an inverter 20) of the stator 2 are mounted on the substrate 5. Further, the connector 51 connectable to an external connection line is arranged on the substrate 5. The external connection line electrically connects the substrate 5 and an external device (for example, an external power supply) of the blower 100. In the present example embodiment, the connector 51 can be connected to, for example, a USB cable. The substrate 5 can receive power from an external device through a USB cable.

Next, the sensors 61, 62, and 63 mounted on the blower 100 will be described.

The acceleration sensor 61 detects acceleration applied to the housing 3. As described above, the motor 101 includes the acceleration sensor 61. The acceleration sensor 61 detects an impact (acceleration) generated by a tap or the like applied to the housing 3 by the user, and transmits a detection result to the controller 8. In the present example embodiment, the acceleration sensor 61 is mounted on the substrate 5. However, this exemplification does not exclude a configuration in which the acceleration sensor 61 is mounted on a member other than the substrate 5. For example, the acceleration sensor 61 may be arranged on a back surface (that is, another axial end surface) of the canopy portion 34.

The temperature sensor 62 detects temperature inside the housing 3, and preferably detects temperature of airflow delivered to the outside of the housing 3. The humidity sensor 63 detects humidity inside the housing 3, and preferably detects humidity of airflow delivered to the outside of the housing 3. For example, in the present example embodiment, the temperature sensor 62 and the humidity sensor 63 are arranged inside the peripheral wall portion 32, and detect temperature and humidity of airflow delivered from the exhaust port 321. A detection result of the temperature sensor 62 and the humidity sensor 63 is transmitted to the controller 8.

In the present example embodiment, the temperature sensor 62 and the humidity sensor 63 are arranged on one axial end surface of the base portion 31. However, the present invention is not limited to this exemplification, and at least one of the two may be arranged on a radially inner surface of the peripheral wall portion 32 or may be arranged on another axial end surface of the canopy portion 34. Alternatively, at least one of the two may be arranged on the exhaust port 321 side (for example, the airflow passage 362).

Note that the above exemplification does not exclude a configuration in which one of the two is omitted. That is, the motor 101 may be configured to include at least one of the temperature sensor 62 and the humidity sensor 63.

The storage unit 7 is a non-transitory storage medium that holds storage also when power supply is stopped (see FIG. 4). The storage unit 7 stores data, a program, and the like used by each constituent element (particularly the controller 8) of the blower 100. Further, the storage unit 7 stores information (for example, input information of the operation device 200) received by the communication portion 106, and the like.

The controller 8 controls each constituent element of the motor 101 and the blower 100 by using, for example, a program, data, and the like stored in the storage unit 7 (see FIG. 4).

For example, the controller 8 controls energization to the stator 2. As described above, the motor 101 includes the controller 8. For example, the stator 2 is driven in accordance with drive current supplied from the inverter 20. The controller 8 controls rotation of the rotor 1 by controlling magnetic drive of the stator 2 under control of the inverter 20.

For example, the controller 8 performs rotation speed change of the rotor 1 based on a detection result of the acceleration sensor 61. Specifically, the controller 8 performs any of a rotation start of the rotor 1, at least one of an increase and a decrease of a rotation speed of the rotor 1, and a rotation stop of the rotor 1. That is, “rotation speed change” of the rotor 1 includes rotation start and a rotation stop of the rotor 1. Hereinafter, performing “rotation speed change” means performing any of a rotation start of the rotor 1, at least one of an increase and a decrease of a rotation speed of the rotor 1, and a rotation stop of the rotor 1.

In this manner, for example, by tapping the housing 3, any of a rotation start of the rotor 1, at least one of an increase and a decrease of a rotation speed, and a rotation stop can be performed. That is, it is possible to perform air blowing start of the blower 100, at least one of an increase and a decrease of an amount of air blowing, and air blowing stop. Therefore, operation of the motor 101 and the blower 100 can be switched by simple operation.

Preferably, the controller 8 controls energization to the stator 2 based on acceleration equal to or more than a threshold in the axial direction detected by the acceleration sensor 61. Note that the threshold may be set in advance at the time of factory shipment or the like, or may be set to a desired value of the user by an input unit (not illustrated) or an operation device (see FIG. 4). In this manner, the controller 8 can control the stator 2 without being affected by acceleration less than the threshold (in particular, an axial component of the acceleration), an acceleration component in a direction intersecting the axial direction, and the like. Therefore, detection accuracy of operation of switching operation of the rotor 1 can be improved. However, this exemplification does not exclude a configuration in which energization to the stator 2 is controlled based on acceleration less than the threshold in the axial direction. Further, this configuration does not exclude a configuration in which energization to the stator 2 is controlled based on acceleration in a direction intersecting the axial direction.

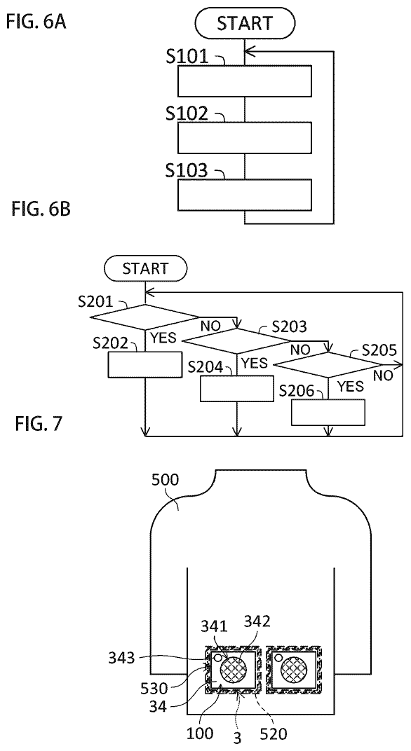

At this time, for example, the controller 8 controls the stator 2 every time acceleration equal to or more than the threshold is detected. By the above, the controller 8 switches operation of the rotor 1 in the order of rotation start, either increase or decrease of a rotation speed, and a rotation stop. FIG. 6A is a flowchart illustrating a control example of the motor 101 and the blower 100. FIG. 6B is a flowchart illustrating another control example of the motor 101 and the blower 100. At start of FIGS. 6A and 6B, the switch 105 is ON, and the motor 101 and the blower 100 can be driven.

For example, in FIG. 6A, when the user first taps the housing 3, the rotor 1 starts to rotate at a low speed, and airflow with smallest air volume setting is delivered from the blower 100 (Step S101).

Next, when the user taps the housing 3, a rotation speed of the rotor 1 and air volume delivered from the blower 100 increase by one level (Step S102). The process in Step S102 may be performed once, or may be performed many times to increase a rotation speed and air volume in stages. Alternatively, in a case where a rotation speed of the rotor 1 and air volume are set to be largest in Step S101, the rotation speed and air volume may be decreased in Step S102.

Next, when the user taps the housing 3, rotation of the rotor 1 is stopped, and blowing of the blower 100 is stopped (Step S103). Then, the processing returns to S101.

On the other hand, even during processing in any of Steps S101 to S103, when the switch 105 is switched from ON to OFF, the motor 101 and the blower 100 become undrivable. For this reason, processing of FIG. 6A ends.

By performing rotation speed change every time acceleration equal to or more than a threshold is detected as illustrated in FIG. 6A, for example, every time the housing 3 is tapped, operation of the rotor 1 can be switched in the above-described order. Therefore, operation of the motor 101 and the blower 100 can be switched by simple operation.

Alternatively, the controller 8 may perform rotation speed change of the rotor 1 by controlling energization of the stator 2 based on the number of times of acceleration equal to or more than a threshold detected within a predetermined period.

For example, in FIG. 6B, in a case where a single tap is detected within a predetermined period (for example, 0.5 [sec]) (YES in Step S201), the rotor 1 starts rotation at a low speed, and airflow with smallest air volume setting is delivered from the blower 100 (Step S202). Then, the processing returns to S201.

Alternatively, in a case where two consecutive taps are detected within a predetermined period (NO in Step S201 and YES in Step S203), the rotor 1 starts rotation at a higher rotation speed than that in Step S202. For this reason, the blower 100 delivers airflow with air volume higher than that in Step S202 (Step S204). Note that in a case where the rotor 1 has already been rotated, rotation of the rotor 1 and air volume of the blower 100 are higher by one level than those in Step S202 in Step S204. Then, the processing returns to S201. Note that processes from Step S203 to Step S204 may be performed once, or may be performed more than once to increase a rotation speed and air volume in stages. Alternatively, in a case where a rotation speed of the rotor 1 and air volume are set to be largest in Step S202, the rotation speed and air volume may be decreased in a process of Step S204.

Alternatively, in a case where three consecutive taps are detected within a predetermined period (NO in Steps S201 and S203 and YES in S205), rotation of the rotor 1 is stopped and blowing of the blower 100 is stopped (Step S206). Then, the processing in FIG. 6B returns to S201.

Note that in a case where four or more consecutive taps are detected within a predetermined period (YES in Step S201 and NO in S201, S203, and S205), the processing in FIG. 6B returns to S201. Alternatively, the present invention is not limited to the exemplification of FIG. 6B, and after proceeding to Step S206, the processing may return to Step S201.

On the other hand, also during the processing in any of Steps S201 to S206, when the switch 105 is switched from ON to OFF, the motor 101 and the blower 100 become undrivable. For this reason, the processing of FIG. 6B ends.

As illustrated in FIG. 6B, by performing rotation speed change according to the number of times of detection of acceleration equal to or more than a threshold within a predetermined period, any of a rotation start of the rotor 1, increase of a rotation speed, decrease of a rotation speed, and a rotation stop can be performed immediately. Therefore, operation of the motor 101 and the blower 100 can be switched by simple operation.

Note that, in FIG. 6B, the predetermined period and the number of consecutive taps within the predetermined period are not limited to those in the above exemplification. For example, the predetermined period may be set in advance at the time of factory shipment or the like, or may be set to a desired value of the user by an input unit (not illustrated) or the operation device 200 (see FIG. 4). The number of consecutive taps within the predetermined period may be similarly set.

Further, as described above, the motor 101 includes at least one sensor of the temperature sensor 62 and the humidity sensor 63. Preferably, the controller 8 further performs rotation speed change of the rotor 1 based on a detection result of at least one of the above sensors. In this manner, a rotation speed of the rotor 1 and ON and OFF of blowing of the blower 100, or air volume can be adjusted according to temperature detected by the temperature sensor 62 and humidity detected by the humidity sensor 63.

For example, when temperature detected by the temperature sensor 62 is equal to or more than a first temperature threshold (for example, 32° C.) or humidity detected by the humidity sensor 63 is equal to or more than a first humidity threshold (for example, 50% RH), the controller 8 starts rotation of the rotor 1 and blowing by the blower 100.

Note that the number of stages of a rotation speed of the rotor 1 may be one or more than one. Note that, for example, in a case where temperature detected by the temperature sensor 62 is equal to or more than the first temperature threshold and lower than a second temperature threshold (for example, 34° C.), or humidity detected by the humidity sensor 63 is equal to or more than the first humidity threshold and lower than a second humidity threshold (for example, 60% RH), the controller 8 rotates the rotor 1 at a first rotation speed.

Further, when temperature detected by the temperature sensor 62 is equal to or more than the second temperature threshold (for example, 34° C.) or humidity detected by the humidity sensor 63 is equal to or more than the second humidity threshold (for example, 60% RH), the controller 8 rotates the rotor 1 at a second rotation speed that is one stage higher than the above-described first rotation speed. Note that, also in a case where there are three or more temperature thresholds and humidity thresholds, the rotor 1 is similarly set to a rotation speed assigned to a temperature range determined from a temperature threshold and a humidity range determined from a humidity threshold.

Further, when temperature detected by the temperature sensor 62 becomes less than the first temperature threshold (for example, 32° C.) or humidity detected by the humidity sensor 63 becomes less than the first humidity threshold (for example, 50% RH), the controller 8 stops rotation of the rotor 1.

Rotation speed change based on detected temperature and detected humidity is particularly effective in the motor 101 for the blower 100 attached to the clothing accessory 500 as described later. For example, it is possible to promote decrease in temperature and humidity inside the clothing accessory 500 or prevent excessive decrease in temperature and humidity according to the above-described detected temperature and detected humidity. Therefore, the controller 8 can adjust the inside of the clothing accessory 500 to comfortable temperature and humidity.

Note that a range of rotation speed of the rotor 1 for which rotation speed change can be performed in Step S102 in FIG. 6A and Step S204 in FIG. 6B described above may be changed based on temperature detected by the temperature sensor 62 or humidity detected by the humidity sensor 63.

For example, a range in which a rotation speed of the rotor 1 is lowest is referred to as a first rotation speed range. Further, a range in which a rotation speed of the rotor 1 is higher than the first rotation speed range is referred to as a second rotation speed range. Further, a range in which a rotation speed of the rotor 1 is higher than the second rotation speed range is referred to as a third rotation speed range.

At this time, when detected temperature is less than the first temperature threshold or detected humidity is less than the first humidity threshold, the controller 8 may select a low-speed rotation mode. Then, the controller 8 may perform rotation speed change according to tap operation in FIG. 6A or 6B within the first rotation speed range that is lowest.

Further, when detected temperature is equal to or more than the first temperature threshold and less than the above-described second temperature threshold, or when detected humidity is equal to or more than the second humidity threshold and less than the above-described second humidity threshold, the controller 8 may select a medium-speed rotation mode. Then, the controller 8 may perform rotation speed change according to tap operation in FIG. 6A or 6B within the second rotation speed range.

Further, when detected temperature is equal to or more than the second temperature threshold or detected humidity is equal to or more than the second humidity threshold, the controller 8 may select a high-speed rotation mode. Then, the controller 8 may perform rotation speed change according to tap operation in FIG. 6A or 6B within the third rotation speed range.

Note that in the above determination, detected temperature may be prioritized, or detected humidity may be prioritized.

Note that rotation speed change may be performed by means other than tapping. Preferably, the controller 8 further performs rotation speed change of the rotor 1 based on a signal received from the operation device 200. For example, operation input for rotation start of the rotor 1, increase or decrease of a rotation speed, and a rotation stop is received by the external operation device 200 (see FIG. 4). The communication portion 106 receives an input signal corresponding to the operation input. The controller 8 controls operation of the rotor 1 according to content of rotation speed change corresponding to the input signal. By the above, the user can easily operate the blower 100 and the motor 101 without directly touching the blower 100. This effect is particularly effective in the motor 101 for the blower 100 attached to the clothing accessory 500. Also when the blower 100 is attached to a portion (Inner side, upper side of back portion, or the like) of the clothing accessory 500 that is difficult for the user to directly touch, the blower 100 and the motor 101 can be easily operated.

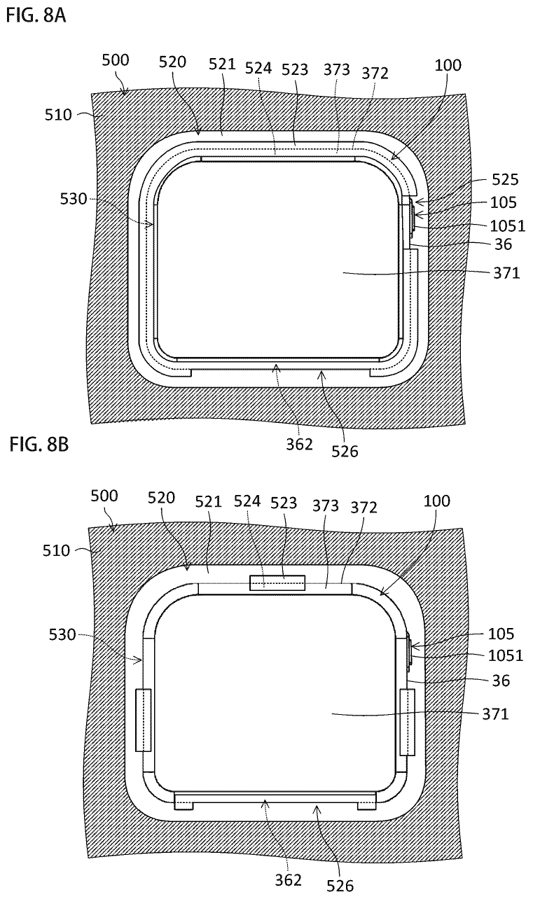

Next, an application example of the blower 100 will be described with reference to FIGS. 2 and 7 to 8B. FIG. 7 is a schematic view illustrating an example of the clothing accessory 500 to which the blower 100 is attached. FIG. 8A is an enlarged view illustrating an attaching example of the blower 100 according to an application example as viewed from the inside of the clothing accessory 500. FIG. 8B is an enlarged view illustrating another attaching example of the blower 100 according to an application example as viewed from the inside of the clothing accessory 500. Note that FIGS. 8A and 8B illustrate the blower 100 as viewed from the other axial direction D2 side toward the one axial direction D1.

As illustrated in FIG. 7, the blower 100 is mounted on the clothing accessory 500. In this manner, operation of the blower 100 can be switched by simple operation such as tapping of the housing 3. Therefore, an internal environment (temperature, humidity, and the like) of the clothing accessory 500 can be made comfortable. Therefore, the user hardly feels discomfort such as heat and stuffiness, and can wear the clothing accessory 500 comfortably.

In the present example embodiment, the clothing accessory 500 is clothing such as outerwear (top). Two of the blowers 100 are attached to the back of outerwear. However, an attaching location of the blower 100 is not limited to this exemplification. For example, the blower 100 may be attached to a front surface of outerwear. Further, the number of the blowers 100 to be attached may be one or three or more.

Preferably, the canopy portion 34 of the blower 100 is arranged outside the clothing accessory 500 and exposed to the outside of the clothing accessory 500. Further, in the present example embodiment, portions other than the canopy portion 34 of the housing 3 are arranged inside the clothing accessory 500 (see, for example, FIGS. 2 and 7). In this manner, the user can easily tap the canopy portion 34, and an impact (that is, acceleration) by tapping can be efficiently transmitted to the acceleration sensor 61.

More preferably, the mark portion 343 is exposed to the outside of the clothing accessory 500. In this manner, the user can more efficiently transmit an impact (that is, acceleration) by tapping to the acceleration sensor 61.

Further, the intake port 341 and the guard portion 342 of the canopy portion 34 are exposed to the outside of the clothing accessory 500. Note that the two are preferably partially exposed.

More preferably, the two are entirely exposed. In this manner, the blower 100 can suck air outside the clothing accessory 500 from the intake port 341. Note that airflow delivered from the blower 100 flows through the inside of the clothing accessory 500, and then is discharged to the outside from a gap connecting the inside and the outside of the clothing accessory 500. Therefore, air in the clothing accessory 500 can be replaced. Therefore, the user can comfortably wear the clothing accessory 500.

However, the above exemplification does not exclude a configuration in which at least a part (in particular, the mark portion 343) of the canopy portion 34 is arranged inside the clothing accessory 500. Further, the above exemplification does not exclude a configuration in which the entire intake port 341 and the entire guard portion 342 of the canopy portion 34 are arranged inside the clothing accessory 500 and are not exposed to the outside. According to the latter, air in the clothing accessory 500 is recirculated in the inside, so that body surface temperature of the user can be lowered. Further, sweat on a body surface can be evaporated, and sticking of an inner surface of the clothing accessory 500 to a body surface can be suppressed or prevented.

Further, preferably, the switch 105 is arranged in a portion inside the clothing accessory 500 of the housing 3. For example, in the present example embodiment, as illustrated in FIGS. 8A and 8B, the switch 105 is arranged on the first outer wall portion 36, and the first outer wall portion 36 is arranged inside the clothing accessory 500. In this manner, it is possible to prevent the switch 105 from being visually recognized from the outside of the clothing accessory 500. Therefore, it is possible to prevent aesthetic appearance of the blower 100 mounted on the clothing accessory 500 from being impaired. Further, a physical switch component such as the switch 105 does not need to be arranged in the canopy portion 34. For this reason, water and dust hardly enter the inside of the housing 3 (particularly, the substrate 5). Therefore, waterproof and dustproof properties of the blower 100 can be improved.

Next, the clothing accessory 500 includes cloth 510 of outerwear, an attachment portion 520, and an opening 530. The opening 530 is formed in the cloth 510. The attachment portion 520 is arranged along an outer edge of the opening 530. The blower 100 is detachably attached to the attachment portion 520. The canopy portion 34 of the blower 100 is inserted into the opening 530 from the inner side of the cloth 510 and is exposed to the outside of the clothing accessory 500.

The attachment portion 520 includes a base frame portion 521, a protruding wall portion 522, and a cover portion 523.

The base frame portion 521 is a plate-shaped frame body expanding along an inner surface of the cloth 510, and is fixed to the cloth 510. In the present example embodiment, the base frame portion 521 is annularly arranged along an outer edge portion of the opening 530. Preferably, an inner edge portion of the base frame portion 521 is in contact with a radially outer end portion of one axial end portion (for example, the lid portion 35) of the housing 3. However, this exemplification does not exclude a configuration in which the base frame portion 521 does not come into contact with the housing 3.

The protruding wall portion 522 protrudes from the base frame portion 521 toward the inside of the clothing accessory 500 (in other words, the other axial direction D2), and expands along an outer edge portion of the opening 530. Further, the protruding wall portion 522 extends along the first outer wall portion 36 and the second outer wall portion 372 of the blower 100 (see, for example, FIG. 2). An inner peripheral surface on the opening 530 side of the protruding wall portion 522 is in contact with the first outer wall portion 36 and the second outer wall portion 372. By the above, the protruding wall portions 522 prevent movement of the blower 100 in a direction in which the base frame portion 521 expands (in other words, in a direction perpendicular to the axial direction). Preferably, the protruding wall portion 522 has flexibility and can be bent from the inside to the outside of the opening 530 when viewed from inside and outside directions of the clothing accessory 500. That is, the protruding wall portion 522 can be bent in the radial direction when viewed from the axial direction.

The cover portion 523 is arranged at a tip portion of the protruding wall portion 522. The cover portion 523 extends toward the inside of the opening 530 (radially inward) as extending toward the inside of the clothing accessory 500 (the other axial direction D2) (see FIG. 2). The cover portion 523 prevents the blower 100 from moving to the inside (the other axial direction D2) of the clothing accessory 500 (see FIG. 2). For example, the cover portion 523 is in contact with the first curved surface 373 of the blower 100. Note that the first curved surface 373 is an example of an “engaging portion” of the present invention. The housing 3 has the first curved surface 373. The cover portion 523 is an example of an “engaged portion” of the present invention. That is, the first curved surface 373 is engaged with the cover portion 523 arranged inside the clothing accessory 500. Further, contact of the cover portion 523 with the first curved surface 373 is an example of an “engagement structure (of an engaging portion and an engaged portion)” of the present invention, and extends in the circumferential direction along a radially outer end portion at another axial end portion of the housing 3. In this manner, the blower 100 can be easily attached to the clothing accessory 500 by contact of the cover portion 523 with the first curved surface 373.

The cover portion 523 has a second curved surface 524. The second curved surface 524 is an inner peripheral surface (radially inner surface) of the cover portion 523 on the opening 530 side (see FIG. 2). The second curved surface 524 of the cover portion 523 is in contact with the first curved surface 373 of the housing 3. As illustrated in FIG. 2, each of the first curved surface 373 and the second curved surface 524 extends radially inward toward the other axial direction D2 when viewed from a direction perpendicular to the radial direction and the axial direction. In this manner, the first curved surface 373 on the blower 100 side is brought into contact with the second curved surface 524 on the clothing accessory 500 side, so that release of attachment of the blower 100 to the clothing accessory 500 can be suppressed or prevented.

For example, as illustrated in FIG. 8A, the cover portion 523 and the protruding wall portion 522 annularly extend over the entire circumferential direction. In other words, contact of the cover portion 523 with the first curved surface 373 annularly extends over the entire circumference of a radially outer end portion of the housing 3. In this manner, the blower 100 can be easily attached to the clothing accessory 500 by fitting the blower 100 to the attachment portion 520 on the clothing accessory 500 side. Furthermore, it is possible to prevent the blower 100 from being easily detached from the attachment portion 520 in the axial direction by contact of the cover portion 523 with the first curved surface 373.

Note that at this time, the protruding wall portion 522 has two openings 525 and 526. The opening 525 is arranged at the same circumferential position as the switch 105 and the connector 51. These are exposed to the outside of the housing 3 through the opening 525. However, the present invention is not limited to this exemplification, and the protruding wall portion 522 may further have an opening arranged at the same circumferential position as the connector 51, separately from the opening 525. The connector 51 can be exposed to the outside of the housing 3 through the opening. In this manner, also after the blower 100 is attached to the clothing accessory 500, the switch 105 can be manually operated. Further, a terminal can be connected to the connector 51. However, this exemplification does not exclude a configuration in which the connector 51 is not exposed to the outside of the housing 3 after the blower 100 is attached to the clothing accessory 500.

Further, the opening 526 is arranged at the same circumferential position as a radially outer end portion of the airflow passage 362. Therefore, the exhaust port 321 communicates with the outside of the housing 3 through the airflow passage 362 and the opening 526. That is, also after being attached to the clothing accessory 500, the blower 100 can send airflow to the outside of the housing 3 through the exhaust port 321, the airflow passage 362, and the opening 526.

Alternatively, as illustrated in FIG. 8B, a plurality of the cover portions 523 and the protruding wall portions 522 may be arranged at intervals in the circumferential direction. In other words, a plurality of contacts of the cover portion 523 with respect to the first curved surface 373 may be arranged at intervals along a radially outer surface of the housing 3. Note that, at this time, a plurality of the protruding wall portions 522 may be arranged at intervals in the circumferential direction as illustrated in FIG. 8B, or may be arranged at intervals in the circumferential direction. Preferably, each of the cover portions 523 is arranged so that the blower 100 is not detached from the attachment portion 520 in a direction (the radial direction) parallel to the cloth 510. For example, when viewed from the axial direction, the cover portion 523 (that is, the engagement structure described above) is arranged at three or more locations, which are dispersed to such an extent that the blower 100 is not detached from the attachment portion 520, in a radially outer end portion of the housing 3. In FIG. 8B, the cover portion 523 (that is, the engagement structure described above) is arranged on both left and right sides and both upper and lower sides of a radially outer end portion of the housing 3. In this manner, the blower 100 can be easily attached to the clothing accessory 500 by fitting the blower 100 to the attachment portion 520 on the clothing accessory 500 side. Furthermore, it is possible to prevent the blower 100 from being easily detached from the attachment portion 520 in the axial direction by contact of the cover portion 523 with the first curved surface 373.

Note that, at this time, preferably, the protruding wall portion 522 is arranged at a circumferential position different from at least any of the switch 105, the connector 51, and a radially outer end portion of the airflow passage 362. That is, the protruding wall portion 522 is arranged so as not to overlap at least any of these. Alternatively, as in FIG. 8A, at least any of the openings 525 and 526 (and an opening for the connector 51) may be formed in the protruding wall portion 522. In this manner, manual operation of the switch 105, connection with the connector 51, and delivery of airflow can be performed without being affected by arrangement of the protruding wall portion 522.

Next, as described above, in the exemplification of FIGS. 8A and 8B, the changeover portion 1051 of the switch 105 is exposed to the outside of the attachment portion 520. By the above, the switch 105 can be manually turned on and off. However, the present invention is not limited to the above exemplification, and the changeover portion 1051 of the switch 105 does not need to be exposed to the outside of the attachment portion 520.

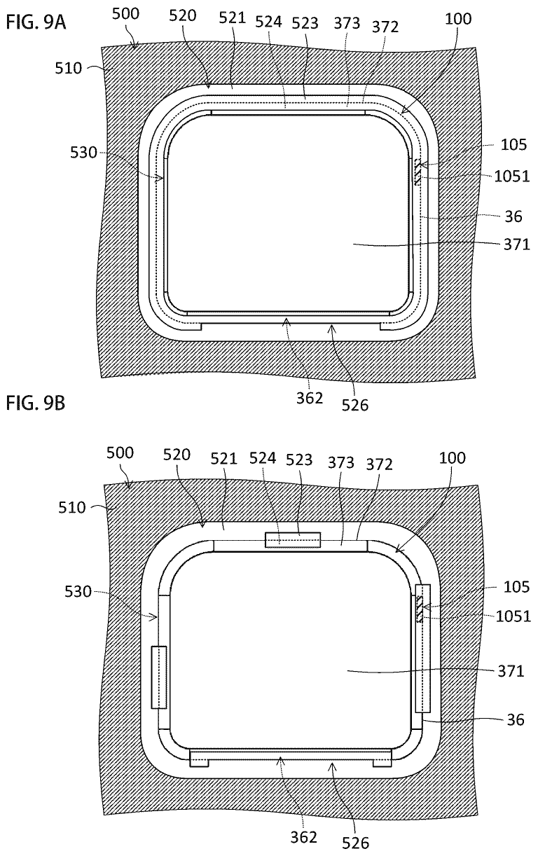

FIG. 9A is an enlarged view illustrating an attaching example of the blower 100 according to another application example as viewed from the inside of the clothing accessory 500. FIG. 9B is an enlarged view illustrating another attaching example of the blower 100 according to another application example as viewed from the inside of the clothing accessory 500. Note that FIGS. 9A and 9B illustrate the blower 100 as viewed from the other axial direction D2 side toward the one axial direction D1.

Hereinafter, a configuration different from the above-described application example illustrated in FIGS. 8A and 8B will be described. Note that the same constituent elements as those in the above-described application example are denoted by the same reference numerals, and may be omitted from description.

In FIGS. 9A and 9B, the switch 105 performs power supply from the battery 103 when the blower 100 is attached to the clothing accessory 500. That is, at the time of attaching, power is supplied from the battery 103 to the blower 100 and the motor 101, and the blower 100 and the motor 101 are driven. On the other hand, when the blower 100 is detached from the clothing accessory 500, the switch 105 stops power supply from the battery 103. That is, when the blower 100 is detached, power is not supplied from the battery 103 to the blower 100 and the motor 101, and the blower 100 and the motor 101 are stopped.

In this manner, driving and stopping of the blower 100 can be switched according to attachment and detachment of the blower 100 to and from the clothing accessory 500. In particular, by simply detaching the blower 100 from the clothing accessory 500, driving of the blower 100 and the motor 101 can be stopped without requiring manual operation (tapping to the blower 100, OFF operation of the switch 105, and the like). Therefore, it is possible to prevent the user from forgetting to turn off driving (including a standby state) of the blower 100 when the blower 100 is not used. Therefore, power consumption of the blower 100 can be reduced, and standby power consumption can also be suppressed. For this reason, it is possible to further lengthen drive time of the blower 100 and the motor 101 that can be used by one time of charging.

Further, it is possible to drive the blower 100 and the motor 101 immediately only by attaching the blower 100 to the clothing accessory 500 without requiring manual operation (tapping to the blower 100, ON operation of the switch 105, and the like).

For example, the switch 105 is a normally-OFF type push button switch. The switch 105 includes the changeover portion 1051. When the blower 100 is attached to the clothing accessory 500, the changeover portion 1051 abuts on the protruding wall portion 522 arranged on the clothing accessory 500. Note that the protruding wall portion 522 is an example of an “abutting portion” of the present invention.

In FIGS. 9A and 9B, the changeover portion 1051 is a push button of a push button switch. Further, in FIG. 9A, the cover portion 523 and the protruding wall portion 522 of the attachment portion 520 annularly extend over the entire circumferential direction. Furthermore, the opening 525 (see FIG. 8A) is omitted. Further, in FIG. 9B, a plurality of the cover portions 523 and the protruding wall portions 522 of the attachment portion 520 are arranged at intervals in the circumferential direction. Further, in FIGS. 9A and 9B, when the blower 100 is attached to the clothing accessory 500, the protruding wall portion 522 abuts on the changeover portion 1051 of the switch 105 and pushes the changeover portion 1051 into the housing 3. That is, when the changeover portion 1051 abuts on the protruding wall portion 522, power supply of the battery 103 is performed. That is, since power is supplied from the battery 103 to the blower 100 and the motor 101, the blower 100 and the motor 101 can be driven.

On the other hand, when the blower 100 is detached from the clothing accessory 500, the changeover portion 1051 protrudes from the inside to the outside of the housing 3 by release of abutment. That is, when abutment between the changeover portion 1051 and the protruding wall portion 522 is released, power supply of the battery 103 is stopped. That is, since power is not supplied from the battery 103 to the blower 100 and the motor 101, the blower 100 and the motor 110 are stopped.

In this manner, it is possible to more easily switch between driving (including a standby state) and stopping of the blower 100 and the motor 101 in accordance with attachment and detachment of the blower 100 to and from the clothing accessory 500. Note that, without limitation to the above

exemplification, the switch 105 may be a switching device other than a push button switch. The switch 105 only needs to be a switching device capable of switching between ON and OFF according to attachment and detachment of the blower 100 to and from the clothing accessory 500 and (for example, whether or not there is abutment between the protruding wall portion 522 and the changeover portion 1051).

Note that without limitation to the above-described application example, and the clothing accessory 500 may be clothing (for example, bottoms) other than outerwear or may be attached to an article that can be attached to the body of the user. For example, the clothing accessory 500 may be attached to headwear such as a hat and a helmet. That is, the clothing accessory 500 may be any of clothing, footwear, headwear, and the like. In this manner, it is possible to suppress or prevent increase in temperature, humidity, and the like inside clothing,, footwear, headwear, and the like. Therefore, an internal environment of these can be maintained comfortably.

The example embodiment of the present invention is described above. Note that the scope of the present invention is not limited to the above-described example embodiment. It is possible to implement the present invention by adding various modifications to the above-described example embodiment within a range not departing from the spirit of the invention. Further, the matters described in the above-described example embodiment can be optionally combined together as appropriate within a range where no inconsistency occurs.

For example, exemplification of the above-described example embodiment does not exclude a configuration in which the blower 100 is other than a centrifugal fan. For example, the blower 100 may be an axial fan.

Hereinafter, the example embodiment described so far and a variation of the example embodiment will be collectively described.

For example, the motor disclosed in the present description has a configuration (first configuration) including:
a rotor rotatable about a central axis extending in the axial direction;
a stator that drives the rotor;
a housing that accommodates the rotor and the stator;
an acceleration sensor that detects acceleration applied to the housing; and
a controller that controls energization to the stator, in which
the controller performs rotation speed change of any of a rotation start of the rotor, at least one of an increase and a decrease of a rotation speed, and a rotation stop based on a detection result of the acceleration sensor.

Note that the motor of the first configuration may have a configuration (second configuration), in which the controller controls energization to the stator based on the acceleration equal to or more than a threshold in the axial direction detected by the acceleration sensor.

Further, the motor of the first or second configuration may have a configuration (third configuration), in which the controller switches operation of the rotor in order of rotation start, either increase or decrease of the rotation speed, and a rotation stop by controlling the stator every time the acceleration equal to or more than a threshold is detected.

Note that the motor of the first or second configuration may have a configuration (fourth configuration), in which the controller performs the rotation speed change of the rotor by controlling energization to the stator based on the number of times of the acceleration equal to or more than a threshold detected within a predetermined period.

Note that the motor according to any of the first to fourth configurations may have a configuration (fifth configuration) further including at least one sensor of a temperature sensor and a humidity sensor, in which
the controller further performs the rotation speed change of the rotor based on a detection result of the at least one sensor.

Note that the motor according to any of the first to fifth configurations may have a configuration (sixth configuration) further including a communication portion that can wirelessly communicate with an external operation device, in which
the controller further performs the rotation speed change based on a signal received from the operation device.

Further, the blower disclosed in the present description has a configuration (seventh configuration) including:
the motor according to any of first to sixth configurations; and
an impeller accommodated in the housing and rotatable together with the rotor about the central axis, in which
the impeller includes:
a hub attached to the rotor; and
an impeller blade that extends radially outward from the hub and expands at least in the axial direction, and
the housing includes:
a peripheral wall portion arranged radially outward of the impeller and surrounding the impeller;
a canopy portion that expands in a radial direction, is arranged further in one axial direction than the rotor, the stator, and the impeller, and covers one axial end portion of the peripheral wall portion;
a first opening that is arranged in the peripheral wall portion and connects an internal space surrounded by the peripheral wall portion and an external space of the housing; and
a second opening that is arranged in the canopy portion and connects an internal space surrounded by the peripheral wall portion and an external space of the housing.

The blower according to the seventh configuration, the blower being attached to a clothing accessory, may have a configuration (eighth configuration), in which
the housing further includes a mark portion having specific display or shape,
the mark portion is arranged on a surface of the canopy portion, and
the canopy portion is arranged outside the clothing accessory.

Further, the blower according to the seventh or eighth configuration may have a configuration (ninth configuration) further including:
a rechargeable battery; and
a switch capable of stopping at least power supply of the battery.

Further, the blower according to the ninth configuration, the blower being attached to a clothing accessory, may have a configuration (tenth configuration), in which
the switch
performs power supply from the battery when the blower is attached to the clothing accessory, and
stops power supply from the battery when the blower is detached from the clothing accessory.

Further, the blower according to the ninth or tenth configuration, the blower being attached to a clothing accessory, may have a configuration (eleventh configuration), in which
the switch includes a changeover portion that abuts on an abutting portion arranged on the clothing accessory when the blower is attached to the clothing accessory,
when the changeover portion abuts on the abutting portion, power supply of the battery is performed, and
when abutment between the changeover portion and the abutting portion is released, power supply of the battery is stopped.

Note that the blower according to any of the ninth to eleventh configurations may have a configuration (twelfth configuration) further including a power receiver capable of wirelessly receiving power from an external power feeding device, in which
the power receiver charges the battery with the received power.

Further, the blower according to any of the ninth to twelfth configurations, the blower being attached to a clothing accessory, may have a configuration (thirteenth configuration), in which the switch is arranged in a portion inside the clothing accessory of the housing.

Further, the blower according to any of the seventh to thirteenth configurations, the blower being attached to a clothing accessory, may have a configuration (fourteenth configuration), in which the housing further includes an engaging portion that engages with an engaged portion arranged inside the clothing accessory.

Further, the blower according to the fourteenth configuration may have a configuration (fifteenth configuration), in which
the housing has a first curved surface in contact with a second curved surface of the engaged portion,
the first curved surface is arranged between another axial end surface and a radially outer surface of the housing, and
each of the first curved surface and the second curved surface extends radially inward toward another axial direction when viewed from a direction perpendicular to the axial direction and the radial direction.

Further, the blower according to the fourteenth or fifteenth configuration may have a configuration (sixteenth configuration), in which a plurality of engagement structures of the engaged portion and the engaging portion are arranged at intervals along a radially outer surface of the housing.

Further, the blower according to the fourteenth or fifteenth configuration may have a configuration (seventeenth configuration), in which an engagement structure of the engaged portion and the engaging portion extends over the entire circumference of a radially outer surface of the housing.

Further, the clothing accessory disclosed in the present description has a configuration (eighteenth configuration), in which the blower having any of the seventh to seventeenth configurations is mounted.

Note that the clothing accessory according to the eighteenth configuration may have a configuration (nineteenth configuration) of being any of clothing, footwear, and headwear.

Example embodiments of the present invention are useful for devices that change operation according to an impact (acceleration) applied from the outside.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-19 (canceled)

20. A motor comprising:
a rotor rotatable about a central axis extending in an axial direction;
a stator to drive the rotor;
a housing to accommodate the rotor and the stator;
an acceleration sensor to detect acceleration applied to the housing; and
a controller configured or programmed to control energization to the stator; wherein
the controller is configured or programmed to perform a rotation speed change of any of a rotation start of the rotor, at least one of an increase and a decrease of a rotation speed, and a rotation stop based on a detection result of the acceleration sensor.

21. The motor according to claim 20, wherein the controller is configured or programmed to control energization to the stator based on the acceleration equal to or more than a threshold in the axial direction detected by the acceleration sensor.

22. The motor according to claim 20, wherein the controller is configured or programmed to switch operation of the rotor in order of the rotation start, either the increase or the decrease of the rotation speed, and the rotation stop by controlling the stator every time the acceleration equal to or more than a threshold is detected.

23. The motor according to claim 20, wherein the controller is configured or programmed to perform the rotation speed change of the rotor by controlling energization to the stator based on a number of times of the acceleration being equal to or more than a threshold detected within a predetermined period.

24. The motor according to claim 20, further comprising at least one of a temperature sensor and a humidity sensor; wherein the controller is configured or programmed to perform the rotation speed change of the rotor based on a detection result of the at least one sensor.

25. The motor according to claim 20, further comprising a communication module to wirelessly communicate with an external operation device; wherein
the controller is configured or programmed to perform the rotation speed change based on a signal received from the operation device.

26. A blower comprising:
the motor according to claim 20; and
an impeller accommodated in the housing and rotatable together with the rotor about the central axis; wherein
the impeller includes:
a hub attached to the rotor; and
an impeller blade that extends radially outward from the hub and extends at least in the axial direction; and
the housing includes:
a peripheral wall portion located radially outward of the impeller and surrounding the impeller;
a canopy portion that extends in a radial direction, extends farther in one axial direction than the rotor, the stator, and the impeller, and covers one axial end portion of the peripheral wall portion;
a first opening in the peripheral wall portion and connects an internal space surrounded by the peripheral wall portion and an external space of the housing; and
a second opening in the canopy portion and connects an internal space surrounded by the peripheral wall portion and an external space of the housing.

27. The blower according to claim 26, wherein
the blower is attached to a clothing accessory;
the housing further includes a mark portion with a specific display or shape;
the mark portion is on a surface of the canopy portion; and
the canopy portion is located outside the clothing accessory.

28. The blower according to claim 26, further comprising:
a rechargeable battery; and
a switch to stop at least a power supply of the battery.

29. The blower according to claim 28, wherein
the blower is attached to a clothing accessory;
the switch is operable to:
perform power supply from the battery when the blower is attached to the clothing accessory; and
stop power supply from the battery when the blower is detached from the clothing accessory.

30. The blower according to claim 28, wherein
the blower is attached to a clothing accessory;
the switch includes a changeover portion that abuts on an abutting portion arranged on the clothing accessory when the blower is attached to the clothing accessory;
when the changeover portion abuts on the abutting portion, power supply of the battery is performed; and
when abutment between the changeover portion and the abutting portion is released, power supply of the battery is stopped.

31. The blower according to claim 28, further comprising a power receiver to wirelessly receive power from an external power feeding device and charge the battery with the received power.

32. The blower according to claim 28, wherein
the blower is attached to a clothing accessory;
the switch is in a portion inside the clothing accessory of the housing.

33. The blower according to claim 26, wherein
the blower is attached to a clothing accessory;
the housing further includes an engaging portion that engages with an engaged portion inside the clothing accessory.

34. The blower according to claim 33, wherein
the housing includes a first curved surface in contact with a second curved surface of the engaged portion;
the first curved surface is between another axial end surface and a radially outer surface of the housing; and
each of the first curved surface and the second curved surface extends radially inward toward another axial direction when viewed from a direction perpendicular to the axial direction and the radial direction.

35. The blower according to claim 33, wherein a plurality of engagement structures of the engaged portion and the engaging portion are arranged at intervals along a radially outer surface of the housing.

36. The blower according to claim 33, wherein an engagement structure of the engaged portion and the engaging portion extends over an entire circumference of a radially outer surface of the housing.

37. A clothing accessory comprising the blower according to claim 26.

38. The clothing accessory according to claim 37, wherein the clothing accessory is any of clothing, footwear, and headwear.
